(19) United States
(12) Patent Application Publication
(10) Pub. No.: US 2005/0174760 A1
(43) Pub. Date: Aug. 11, 2005

(54) Lighting device

(76) Inventors: Piero Perlo, Italy (IT); Rosella Monferino, Italy (IT); Anatolii Zezdine, Italy (IT); Piermario Repetto, Italy (IT); Nello Li Pira, Italy (IT); Mazria Paderl, Italy (IT); Vito Lambertini, Italy (IT); Davide Capello, Italy (IT); Cosimo Carvignese, Italy (IT); Giovanni Brusco, Italy (IT); Bartolo Pairetti, Italy (IT)

Correspondence Address: SUGHRUE MION, PLLC, 2100 PENNSYLVANIA AVENUE, N.W., SUITE 800, WASHINGTON, DC, 20037, US

(21) Appl. No.: 10/470,306

(22) PCT Filed: Jan. 17, 2003
(86) PCT No.: PCT/IB03/00123

(30) Foreign Application Priority Data
Feb. 1, 2002 (IT) T02002A000090

(51) Int. Cl. F21L 19/00

(52) U.S. Cl. 362/159

(57) ABSTRACT

A lighting device has a light source, comprising a volume (11) inside which combustion of a fuel-comburent mixture is confined. A photonic crystal structure (16) is positioned inside the volume (11). The photonic crystal structure (16) operates to inhibit or limit emission from said passage of at least a part of infrared radiation and simultaneously allow emission of visible light radiation. (FIG. 1)

The present invention relates to a lighting device.

At the current state of the art various types of lighting devices or systems are known, in which the light source is composed of the flame of a burner, fed by a liquid or gaseous fuel. Although widely diffused, these known devices are somewhat inefficient due to the high emission of infrared radiation and to the lack of control over the dosage of reagent materials, such as fuel and oxidant.

On the basis of the above, the aim of the present invention to produce a light source of new conception in which emission of infrared radiation is minimized, although utilizing direct combustion as energy source.

Another aim of the invention is to produce a light source in which control of the dosage of reagent materials, such as fuel and oxidant, may be obtained electronically.

Another aim of the invention is to produce a light source in which spatial control of the fuel-comburent reaction zone in which light emission originated is possible.

One or more of these aims are attained, according to the present invention, by a lighting device with a light source operating on the principle of confinement in a volume of the chemical reaction between at least a fuel and a comburent, wherein at least a passage for the emission from said volume of the light developed by said reaction is provided, with a photonic crystal structure disposed in correspondence of said passage, operating to inhibit or limit emission from said passage of at least a part of the infrared radiation and to simultaneously allow emission of visible light radiation.

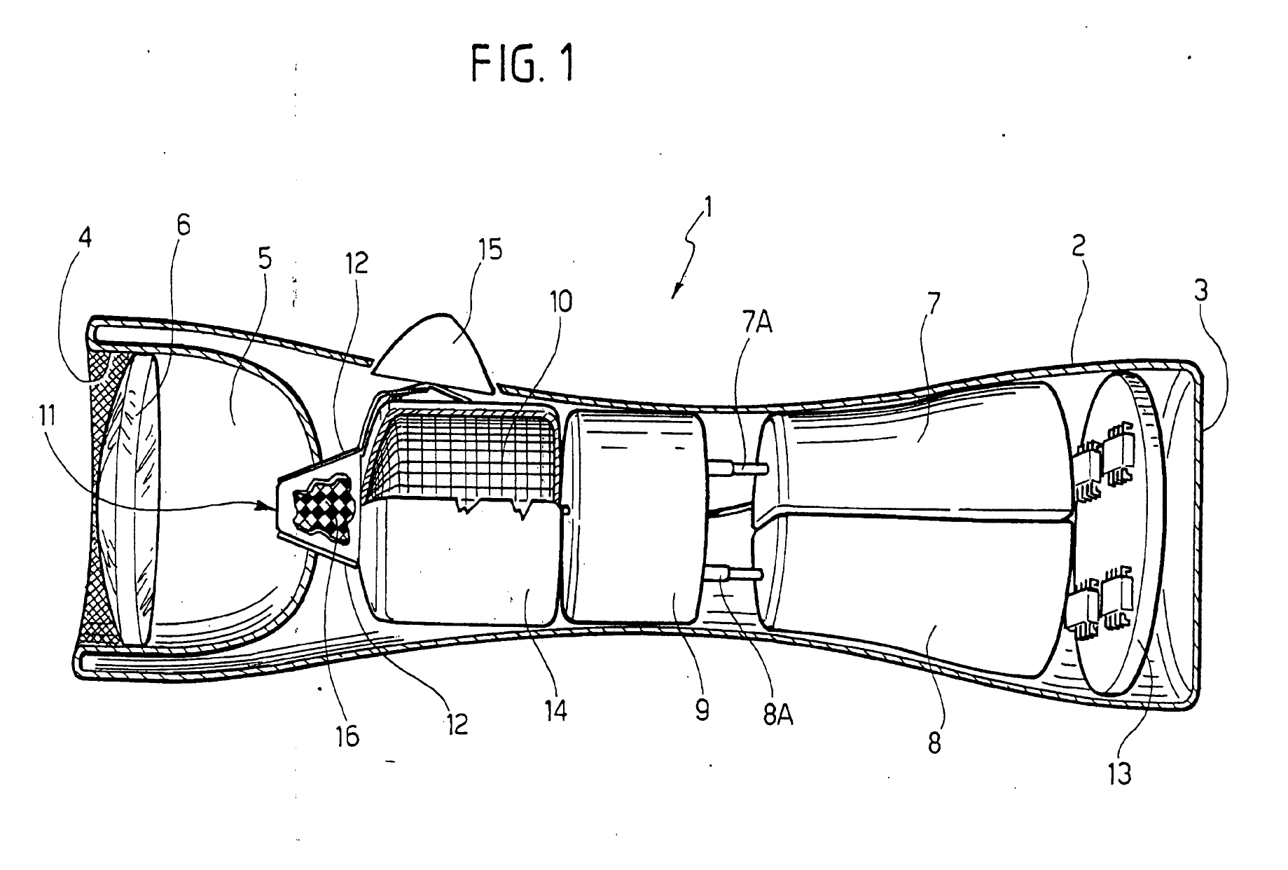

Further aims, characteristics and advantages of the present invention will become apparent from the description below and from the attached drawings, provided purely as a non-limiting example, in which:
FIG. 1 is a partly sectional side view of a lighting device with direct combustion obtained according to the precepts of the present invention.

The attached figure represents a light source with direct combustion obtained according to the precepts of the present invention; in the example, this light source a lighting device, in the form of a portable lamp, indicated as a whole with 1.

The device 1 comprises a hollow casing 2, produced for example in plastic, metal or glass material, closed at one end by a first substantially flat end wall, indicated with 3. At the opposite end is a wall concave 4 towards the inside of the body 2, associated with which is a reflector, for example of the parabolic type or of the free-form type, indicated schematically with 5; the reflector 5 may for example be produced by coating the wall 4, when it is produced in plastic material, with a reflecting coating, in a single layer or multiple layers, with a technique known per se; as an example, the aforesaid coating may be in the form of layers of aluminum or silver.

Positioned on the reflector 5 is a flat, primate or lenticular transparent element, indicated with 6; the transparent element 6 may for example be made of glass.

Inside the casing 2, between the bottom wall 3 and the wall 4 (or between the bottom wall 3 and the reflector 5, if the latter replaces the wall 4), various functional components of the device 1 are positioned.

The numerals 7 and 8 indicate two tanks, to contain a fuel and a comburent respectively. It must be noted that the combustive mixture required to operate the device 1 may be composed of two gases (such as hydrogen or acetylene and oxygen) or of a gas and a liquid (such as oxygen and methanol).

The tanks 7 and 8 communicate, by means of respective ducts 7A and 8A, with respective inlets of an injector device, indicated as a whole with 9, provided to produce the combustive mixture and feed it to a homogenization zone or chamber of the mixture, indicated with 10, containing a porous material.

At the opposite end of the homogenization chamber 10 to the end connected to the injector device 9 an outlet is defined, at the level of which is a tubular appendix 11, tapered like a nozzle and represented in section; the appendix 11 passes through an aperture defined in the concave wall 4 and leads inside the reflector 5.

In the example, associated with the appendix 11 are two electrodes, indicated with 12, destined to be supplied with electricity to produce a jump spark to ignite the flame coming from the homogenization chamber 10; for this purpose the electrodes 12, made of metal, each have a respective portion, not shown, pointed towards the interface between the homogenization chamber 10 and the nozzle appendix 11, in order to facilitate the electric spark to ignite the mixture; this spark is generated by means of an electronic control system, indicated schematically with 13, fed by means of an appropriate battery, not shown in the figure; the electronic system 13 is also in charge of controlling the injector device 9, for the purposes which shall become more apparent hereunder.

The homogenization chamber 10 must preferably be stable to chemical agents and high temperatures and guarantee minimum heat losses. For this purpose, the chamber 10 may be produced using a new extremely resistant ceramic material, namely SiC·nSi₃N₄·xC, with the external walls coated in zirconium oxide doped with thallium and yttrium oxides, which act as a thermal barrier; this coating, shown partly sectioned, is indicated with 14.

A generic combustion chamber of reduced size also tends to cause recombination of the active radical species, increasing the probability of the reaction being extinguished. For this reason, according to the invention, the combustion chamber 10 is also provided with catalysts of a type known per se, aimed at preventing said recombination.

The numeral 15 indicates a selector switch, of the type known per se, provided to control switching on of the device 1 by means of the system 13; the latter is in particular designed to control the impulse frequency of ignition and injection of the combustive mixture inside the chamber 10, said frequency which may if necessary be adjusted using the selector switch 15. For this purpose, the electrodes 12, the injector device 9 and the selector switch 15 are suitably connected to the control system 13, by means of electric conductors, not shown in the figure.

According to an important aspect of the present invention, a photonic crystal structure is positioned at the level of the outlet aperture of the homogenization chamber 10; in the case exemplified in the figure, therefore, this photonic crystal structure, indicated with 16, is introduced inside the nozzle appendix 11.

The theory underlying photonic crystals originates from the works of Yablonovitch and translates into the possibility of producing materials with characteristics that influence the properties of photons, just as semiconductor crystals influence the properties of electrons. Yablonovitch proved that materials with structures having a periodic variation in the refraction index may drastically modify the nature of the photonic modes inside them.

In greater detail, the electrons which move in a semiconductor crystal feel the effect of a periodic potential created by interaction with the nuclei of the atoms of which the crystal is composed; this interaction causes the formation of a series of allowed energy bands, separated by forbidden energy bands (Band Gap).

A similar phenomenon occurs for the photons in the photonic crystals, which are generally composed of blocks of transparent dielectric material containing an orderly series of microcavities in which air or another means with a very different refraction index to the index of the guest matrix is trapped. The contrast between the refraction indices causes confinement of photons with specific wavelengths inside the cavities of the photonic crystal.

The confinement which the photons (or the electromagnetic waves) feel, the effect of, due to the contrast between the refraction indices of the porous matrix and the cavities causes the formation of regions of permitted energies, separated by regions of prohibited energies. The latter are called Photonic Band Gaps. This fact gives rise to the two fundamental properties of photonic crystals:

i) by controlling the dimensions, the distance between the cavities and the difference between the refraction indices, it is possible to prevent propagation and spontaneous emission of photons of specific wavelengths;

ii) as in the case of semiconductors, where there are dopant impurities inside the Photonic Band Gap (P.B.G.) it is possible to create permitted energy levels.

By appropriately selecting the values of the parameters which define the properties of the photonic crystals, it is therefore possible to prevent propagation and spontaneous emission of infrared radiation of specific wavelengths, and simultaneously allow propagation and spontaneous emission of visible radiation.

Operation of the device 1 according to the invention is as follows.

The tanks 7 and 8 normally contain a fuel and a comburent which, as mentioned, may be composed of two gases or a gas and a liquid. Through the ducts 7A and 8A, the fuel and the comburent can reach the injection device 9, typically composed of a microvalve of the ink-jet or bubble-jet type, to be mixed together and fed to the homogenization chamber 10.

In the preferred embodiment of the invention, injection of the combustive mixture into the homogenization chamber 10 is produced with impulses.

Injection with impulses allows greater control over dosing of fuel and oxidant to regulate stoichiometric combustion in which the fuel and oxidant react without lean or rich reaction products according to the oxidant to fuel ratio.

As mentioned, in a possible embodiment, injection of the combustive mixture is produced through an injection device similar to those used in the ink-jet heads for printers, of the ink-jet or bubble-jet type, well known per se also for use in different sectors (see, for example, U.S. Pat. No. 5,437,255 relative to the use of an injection system of the type indicated for internal combustion engines).

In particular, the recent generations of injector devices of the ink-jet type, both thermal and piezoelectric, are characterized by an extremely high level of performance in terms of quality, reliability and low cost. Characteristics typical of these systems are the fact they can be used both with liquid mixtures and with gaseous mixtures, control over the size of droplets, the injection time and the mixing flow of the two components. The typical frequency that can be imputed may vary from a few Hertz to a few tens of thousands of Hertz, with the possibility of injecting quantities of liquid of around a picolitre for each impulse.

To start confined combustion at the outlet of the chamber 10, the user of the device 1 operates the selector switch 15, to start, by means of the control system 13, a sequence of admissions of the mixture from the injector device 9 to the chamber 10, with a corresponding number of electric sparks between the electrodes 12, preferably delayed to optimize ignition synchronization.

In a preferred embodiment of the invention, moreover, following the first spark the injection sequence and frequency of the fuel-comburent injected guarantees self-ignition of the impulses.

Therefore, in the inlet zone of the appendix 11 in which the photonic crystal 16 is positioned combustion with impulses takes place, that is a succession of single combustions of jets of mixture injected one after another; the first combustion may be started by a respective spark between the electrodes 12 and characterized by the development of a respective flash of light, while from the second combustion, ignition may take place as a result of local heating of the aforesaid inlet zone, and in particular as a result of injection of an impulse of fuel-comburent in an area in which combustion of the previous impulse has not yet terminated. The frequency of these combustions and flashes will depend on the setting made using the selector switch 15. It must also be noted that, in the event of low frequency, it may be necessary for a specific spark to correspond to each impulse.

As mentioned, a photonic crystal structure 16 is provided inside the hollow appendix 11; this structure 16, according to the invention, has a Photonic Band Gap in the near infrared. In this way the property of the photonic crystal 16 is exploited to prevent emission and propagation of infrared radiation, as this represents the greater part of radiation emitted by the chemical reaction of combustion with light emission. For this purpose, the photonic crystal structure 16 may for example be based on silica, titania or aluminum oxide, and obtained by chemical synthesis using the “self assembly” and “lost wax” techniques.

The beam of light which can be emitted from the appendix 11 hits the reflector 5, which reflects the visible light radiation outside the device 1 through the element 6 in flat, primate or lenticular transparent glass.

As mentioned, thanks to the presence of the photonic crystal structure 16, emission of infrared radiation is minimized, with a consequent increase in the efficiency of the device 1 compared with prior art.

The invention has been described with reference to a portable lamp; however, it is clear that it is may be applied in order to produce any type of lighting device, system or plant.

It is apparent that the lighting device described as an example may be subject to numerous variants by those skilled in the art, without however departing. from the scope of intrinsic novelty of the inventive idea.

In a possible variant of the invention, feed of the combustive mixture into the homogenization chamber 10 may take place through capillarity, rather than being produced by means of a specific injector; in this solution the injector device 9 is eliminated, where the fuel and the comburent reach the chamber 10 directly, which as in the previous case will be filled with a material with controlled porosity; impregnation of this porous material allows the mixture to reach the cavities of the photonic crystal 16, at the level of which the electrodes 12 to ignite the mixture will be positioned.

In the case exemplified previously, the selector 15 and the control system 13 operate to allow variation of the frequency of the ignition impulses and, if foreseen, injection of the combustive mixture; nonetheless, it is clear that in other embodiments of the invention, this frequency may be fixed.

The tanks of the device, whether of the portable type or installed fixed, may advantageously be refillable or replaceable.

In a further, more complex, layout, the fuel tank may comprise three dividing walls, defining three containers in which three different fuels are positioned, each container being equipped with a respective ink-jet injection system and containing a respective fuel with the addition of nanoscopic particles or clusters of particles, operating to define the color emitted from the passage 11.

Combustion of the fuels thus generates radiation of color determined by the type of particles introduced into the fuel; these particles or clusters of particles are preferably agglomerated so that the porosity of the cluster facilitates reactivity with the oxidant; the dimension and type of particles in the cluster thus define the color of the dominant radiation in combustion. The aforesaid particles may be aluminum, silver, porous silicon and other types of alkaline metals or semiconductors known for their emission selectivity in relation to the degree of porosity or dimension.

The color of the radiation emitted will be defined, as well as by the photonic crystal 16, also by the type of particles introduced in the fuel. The color perceived by the human eye is therefore the result of the RGB base colors of radiation emitted by the reaction zone (that is the inlet of the passage 11) and remaining in the reaction zone according to sequences and times definable through regulation of the injection frequency of the fuel of the defined color.

The homogenization chamber 10 may also have a plurality of light outlet passages, at the level of which respective photonic crystal structures are provided.

1. Lighting Device, with a light source operating on the principle of confinement in a volume of the chemical reaction between at least a fuel and a comburent, characterized in that it provides at least a passage (11) for the emission from said volume of the light developed by said reaction, a photonic crystal structure (16) being disposed in correspondence of said passage (11), operating to inhibit or limit emission from said passage of at least a part of the infrared radiation and to simultaneously allow emission of visible light radiation.

2. Device according to claim 1, characterized in that within the ambit of said photonic crystal structure (16) there are defined a multitude of microcavities in which a means with a different refraction index to the index of the material constituting said structure is present.

3. Device according to claim 1, characterized in that said passage (11) is located in the focal zone of a reflector (5), the latter being in particular of the parabolic type or preferably of the free-form type.

4. Device according to claim 1, characterized in that it provides ignition means (12), operating to produce an electric spark and/or a succession of electric sparks to ignite the fuel-comburent mixture, said ignition means (12) being in particular within the ambit of said passage (11) or in any case in proximity to said photonic crystal structure (16).

5. Device according to claim 1, characterized in that it provides injector means (9) of the impulse type, comprising in particular an injection system of the ink-jet type developed with piezo or bubble technology, to feed said fuel and said comburent into a homogenization zone (10) of the fuel-comburent mixture.

6. Device according to claim 4 and/or 5, characterized in that it provides means to control (13) the generation frequency of said sparks and/or the injection frequency of said fuel.

7. Device according to claim 6, characterized in that selection means (15) are provided to regulate the generation frequency of said, sparks and/or the injection frequency of said fuel and said comburent.

8. Device according to claim 1, characterized in that said homogenization zone (10) has a casing (14) supporting a porous material, said casing (14) being produced in ceramic material, such as in particular SiC ·nSi₃N₄·xC.

9. Device according to claim 8, characterized in that the external walls of said casing (14) which defines said homogenization zone (10) are covered with a protective coating, in particular, zirconium oxide doped with thallium and yttrium oxides.

10. Device according to claim 1, characterized in that it provides in said volume and/or said passage (11) catalyst means are provided, aimed at preventing recombination of active radical species.

11. Device according to claim 1, characterized in that said structure (16) is positioned inside a substantially tubular appendix (11), positioned in correspondence of said passage.

12. Device according to claim 11, characterized in that said appendix (11) operates to direct a beam of visible light radiation emitted from said passage towards a reflector (5).

13. Device according to claim 1, characterized in that said structure (16) is based on a material selected in the group comprising silica, titania and alumina.

14. Device according to claim 1, characterized in that it comprises means (7,8,9) to feed said fuel to said volume together and/or mixed with a comburent.

15. Device according to claim 14, characterized in that said means comprise a first and a second tank (7,8), to contain said fuel and said comburent respectively.

16. Device according to claim 14, characterized in that said means (7, 8, 9) comprise a mixing chamber, inside which said fuel is mixed with said comburent.

17. Device according to claim 16, characterized in that said chamber contains a material with controlled porosity.

18. Device according to claim 15, characterized in that said first tank (7) comprises various fuel compartments, each equipped with a respective system for injection into said volume, with nanoscopic particles or clusters of particles, which contribute for defining the color emitted from the passage (11), being added to the fuel of each compartment.

19. Device according to claim 18, characterized in that said photonic crystal structure (16) operates to define the color of the radiation emitted from said passage (11), said color also being defined by the type of particles introduced into each fuel utilized, the color perceived by the human eye being the result of the RGB base colors of radiation emitted from said passage (11).

20. Device according to claim 6, characterized in that it provides means (13) to regulate the. delay between an electric spark and the injection of the fuel-comburent mixture into said volume.

21. Device according to claim 6, characterized in that said control means (13) operate to maintain said chemical reaction active following to a single ignition spark of the fuel-comburent mixture.
The foregoing substantially as described and illustrated and for the purposes herein specified.
